(19) United States
(12) Patent Application Publication
(10) Pub. No.: US 2024/0173107 A1
(43) Pub. Date: May 30, 2024

(54) DATA PROCESSING DEVICE AND DATA PROCESSING METHOD

(71) Applicant: MEDIT CORP., Seoul (KR)

(72) Inventors: Dong Hoon LEE, Seoul (KR); Ho Taik LEE, Seoul (KR)

(73) Assignee: MEDIT CORP., Seoul (KR)

(21) Appl. No.: 18/283,651

(22) PCT Filed: Mar. 4, 2022
(86) PCT No.: PCT/KR2022/003076

§ 371 Date: Sep. 22, 2023

(30) Foreign Application Priority Data
Mar. 24, 2021 (KR) 10-2021-0038282
Oct. 29, 2021 (KR) 10-2021-0147065

(51) Int. Cl. A61C 9/00; G06T 19/20; G06V 10/74

(52) U.S. Cl. CPC A61C 9/0053; G06T 19/20; G06V 10/761; G06T 2219/2004

(57) ABSTRACT

Disclosed is a data processing method performed by a data processing device, the data processing method including obtaining a first scan model and a second scan model, determining whether to initially align the first scan model and the second scan model, and in response to determining not to initially align the first scan model and the second scan model, precisely aligning the first scan model and the second scan model.

### TECHNICAL FIELD

The disclosed embodiments relate to a data processing device and a data processing method, and more particularly, to a device and method for processing an intraoral image.

### BACKGROUND ART

Three-dimensional scanners have been used for dental treatment of patients. Three-dimensional scanners may be of a handheld type, which may be inserted in and withdrawn from a patient's oral cavity, or a table scanner type, which may scan a plaster cast placed on a table while rotating the table.

A computing device such as a personal computer (PC) connected to a three-dimensional scanner may generate a three-dimensional intraoral image by using raw data obtained by the three-dimensional scanner.

In some cases, a user such as a dentist may align a plurality of three-dimensional intraoral images with each other by using a computing device. The user may manually select a matching point in each of two three-dimensional intraoral images to be aligned, such that the two three-dimensional intraoral images are aligned with each other.

Alternatively, the user may select automatic alignment by using a user interface, or the like, such that the computing device automatically aligns the plurality of three-dimensional intraoral images. The computing device first performs initial alignment on the plurality of three-dimensional intraoral images to be aligned, and perform precise alignment, for example, iterative closest point (ICP) alignment, in order to more accurately align the initially aligned images. In some cases, the user may determine that the initial alignment of the plurality of three-dimensional intraoral images has been well performed, but the precise alignment has not been accurately performed. In this case, the user may want to perform only precise alignment on the three-dimensional intraoral images again. However, when the user selects the automatic alignment again, the computing device performs the initial alignment first and then the precise alignment, and in some cases, data is likely to be aligned in a position that is more incorrect than the position before the alignment. Therefore, there is a need for a method and device capable of more conveniently and accurately aligning a plurality of three-dimensional intraoral images.

### DESCRIPTION OF EMBODIMENTS

### Solution to Problem

A data processing method performed by a data processing device according to an embodiment includes obtaining first scan data and second scan data, determining whether to initially align the first scan data and the second scan data, and in response to determining not to initially align the first scan data and the second scan data, precisely aligning the first scan data and the second scan data.

### BRIEF DESCRIPTION OF DRAWINGS

FIG. 1 is a diagram for describing an intraoral image processing system according to an embodiment.

FIG. 2 is an internal block diagram of a data processing device according to an embodiment.

FIG. 3 is an internal block diagram of a processor of FIG. 2, according to an embodiment.

FIG. 4 is a diagram illustrating an example of the data processing device of FIG. 2.

FIG. 5 is a diagram for describing a method, performed by a data processing device, of determining whether to perform initial alignment, according to an embodiment.

FIG. 6 is a diagram for describing a method, performed by a data processing device, of performing automatic alignment, according to an embodiment.

FIG. 7 is a diagram for describing a method, performed by a data processing device, of performing automatic alignment, according to another embodiment.

FIG. 8 is a flowchart illustrating a process of automatically aligning scan models, according to an embodiment.

FIG. 9 is a flowchart illustrating a method of determining to omit initial alignment of scan models, according to an embodiment.

FIG. 10 is a flowchart illustrating a method of determining to omit initial alignment of scan models, according to another embodiment.

### MODE OF DISCLOSURE

In an embodiment, the determining of whether to initially align the first scan data and the second scan data may include determining whether a relationship between the first scan data and the second scan data satisfies a first alignment criterion, and in response to determining that the relationship between the first scan data and the second scan data satisfies the first alignment criterion, determining not to initially align the first scan data and the second scan data.

In an embodiment, the determining of whether the relationship between the first scan data and the second scan data satisfies the first alignment criterion may include determining whether a distance between a point on the first scan data from which a normal vector is projected, and a point at which the normal vector intersects the second scan data is less than or equal to a first threshold value, and in response to the distance being less than or equal to the first threshold value, determining that the first alignment criterion is satisfied.

In an embodiment, the determining of whether the distance between the point on the first scan data from which the normal vector is projected, and the point at which the normal vector intersects the second scan data is less than or equal to the first threshold value may include obtaining distances between a plurality of points on the first scan data, and a plurality of points at which the normal vectors intersect the second scan data, respectively, and in response to a statistical property value of a distribution of the distances being less than or equal to the first threshold value, determining that the relationship between the first scan data and the second scan data satisfies the first alignment criterion, and the statistical property value may include at least one of a minimum, a maximum, a median, an average, an absolute average, a mode, a range, and a variance of the distribution of the distances.

In an embodiment, the determining of whether the distance between the point on the first scan data from which the normal vector is projected, and the point at which the normal vector intersects the second scan data is less than or equal to the first threshold value may include obtaining a proportion of distances that are less than or equal to the first threshold value, among distances between a plurality of points on the first scan data, and a plurality of points at which the normal vectors intersect the second scan data, respectively, and in response to the proportion of the distances being greater than or equal to a reference value, determining that the relationship between the first scan data and the second scan data satisfies the first alignment criterion.

In an embodiment, the method may further include determining whether a relationship between the precisely aligned first scan data and second scan data satisfies a second alignment criterion, and in response to determining that the relationship between the precisely aligned first scan data and second scan data does not satisfy the second alignment criterion, initially aligning the precisely aligned first scan data and second scan data, wherein the determining of whether the relationship between the precisely aligned first scan data and second scan data satisfies the second alignment criterion may include determining whether a distance between a point on the precisely aligned first scan data from which a normal vector is projected, and a point at which the normal vector intersects the precisely aligned second scan data is less than or equal to a second threshold value, and in response to the distance between the point on the precisely aligned first scan data from which the normal vector is projected, and the point at which the normal vector intersects the precisely aligned second scan data being less than or equal to the second threshold value, determining that the second alignment criterion is satisfied, and the second threshold value may be less than the first threshold value.

In an embodiment, the method may further include, in response to determining to initially align the first scan data and the second scan data, initially aligning the first scan data and the second scan data, and precisely aligning the initially aligned first scan data and second scan data.

In an embodiment, the method may further include outputting a user interface screen for selecting automatic alignment, wherein the determining of whether to initially align the first scan data and the second scan data may be performed in response to the automatic alignment being selected on the user interface screen.

A data processing device according to an embodiment includes a processor configured to execute one or more instructions to obtain first scan data and second scan data, determine whether to initially align the first scan data and the second scan data, and in response to determining not to initially align the first scan data and the second scan data, precisely align the first scan data and the second scan data.

A computer-readable recording medium according to an embodiment has recorded thereon a program for executing a data processing method, the data processing method including obtaining a first scan model and a second scan model, determining whether to initially align the first scan model and the second scan model, and in response to determining not to initially align the first scan model and the second scan model, precisely aligning the first scan model and the second scan model.

In the present specification, the principle of the present disclosure is described and embodiments are provided in such a manner that the scope of the present disclosure becomes apparent and the present disclosure may be carried out by those of skill in the art to which the present disclosure pertains. The disclosed embodiments may be implemented in various forms.

Like reference numerals denote like elements throughout the present specification. The present specification does not describe all elements of embodiments, and general content in the art to which the present disclosure pertains or identical content between the embodiments will be omitted. The terms ‘part’ and ‘portion’ as used herein may be embodied as software or hardware, and a plurality of ‘parts’ may be embodied as a single unit or element, while a single ‘part’ may include a plurality of elements, according to embodiments. Hereinafter, an operating principle and embodiments of the present disclosure will be described with reference to the accompanying drawings.

In the present specification, an image may include an image representing at least one tooth, an oral cavity including at least one tooth, or a plaster cast of an oral cavity (hereinafter, referred to as an ‘intraoral image’).

In addition, in the present specification, an image may include a two-dimensional image of an object, or a three-dimensional intraoral image representing an object in three dimensions. In addition, the three-dimensional intraoral image may be generated by modeling the structure of the oral cavity in three dimensions based on raw data, and thus may be referred to as a three-dimensional intraoral model. In addition, the three-dimensional intraoral model may be referred to as a scan model or scan data.

Hereinafter, in the present specification, the term ‘intraoral image’ will be used as a generic term for a model or image representing an oral cavity in two dimensions or three dimensions.

In addition, in the present specification, data may refer to information necessary for representing an object in two dimensions or three dimensions, for example, raw data obtained by using at least one camera.

In detail, the raw data is data obtained to generate an intraoral image, and may be data (e.g., two-dimensional data) obtained by at least one image sensor included in a three-dimensional scanner when an object is scanned by using the three-dimensional scanner. Raw data obtained by a three-dimensional scanner may also be referred to as two-dimensional image data. Raw data may refer to two-dimensional images from different viewpoints obtained by a plurality of cameras when an object is scanned by using a three-dimensional scanner.

Although it is described above that the raw data is two-dimensional images, but is not limited thereto and may also be three-dimensional image data.

In the present specification, an object refers to an object to be photographed and may include a part of a human body or a model of a part of a human body. The object may include an oral cavity, a plaster cast or impression of an oral cavity, an artificial structure that is insertable into an oral cavity, or a plaster cast or impression of an artificial structure. For example, the object may be a tooth, gingiva, a plaster cast or impression of a tooth or gingiva, and/or may include an artificial structure insertable into an oral cavity, or a plaster cast or impression of such an artificial structure. Here, the artificial structure insertable into an oral cavity may include, for example, at least one of an orthodontic device, an implant, a crown, an inlay, an onlay, an artificial tooth, and an orthodontic auxiliary tool to be inserted into an oral cavity. In addition, the orthodontic device may include at least one of a bracket, an attachment, an orthodontic screw, a lingual orthodontic device, and a removable orthodontic retainer.

In various situations, a user such as a dentist may want to align a plurality of three-dimensional intraoral images. For example, the user may align a plurality of intraoral images obtained by scanning the same object before and after a certain period in order to compare conditions of an oral cavity with each other. Alternatively, when placing a prosthesis on a patient's tooth, the user may align a scan model of the prosthesis on a scan model of the patient's tooth in order to check whether the prosthesis fits well with the patient's tooth.

Alternatively, the user may obtain a more accurate occlusion image by obtaining three-dimensional intraoral images of upper and lower jaws and occlusion, and then aligning the images of the upper and lower jaws with the image of the occlusion.

In such various situations, the user may perform alignment on a plurality of three-dimensional intraoral images.

Whenever the user requests automatic alignment, a computing device first performs initial alignment and then performs precise alignment. There may be cases in which the user wants more accurate precise alignment in a state in which initial alignment has been performed to some extent on the three-dimensional intraoral images. However, there may be cases in which, when the user requests automatic alignment, the computing device consistently performs the initial alignment again, and thus, the alignment positions of the intraoral images after performing the initial alignment are more incorrect than the alignment positions before performing the initial alignment.

The disclosed embodiments are to overcome the above-described issue, and provide a data processing device and method for first determining whether a relationship between a plurality of intraoral images to be aligned satisfies an alignment criterion, and, based on a result of the determining, determining whether to perform initial alignment.

Hereinafter, embodiments will be described in detail with reference to the drawings.

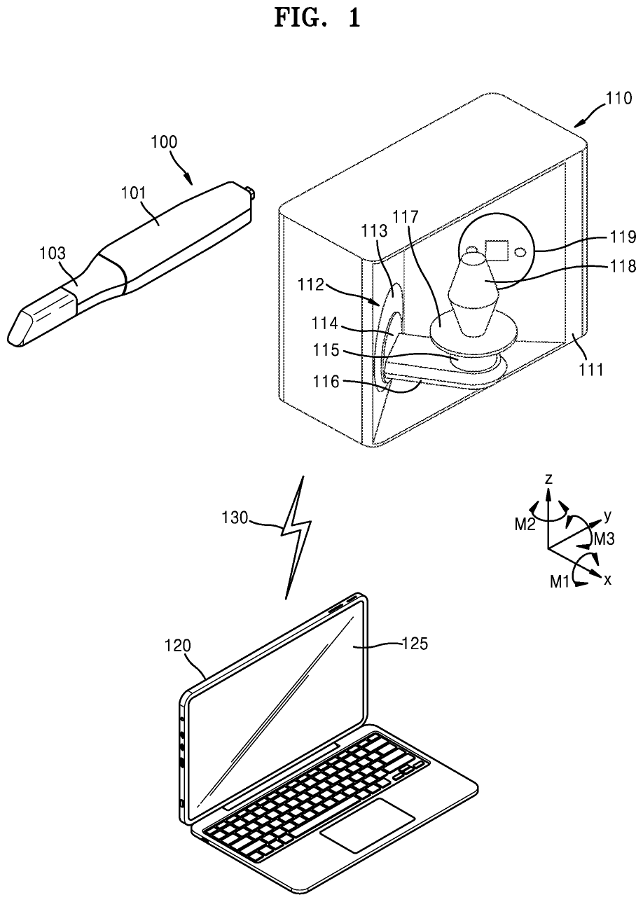

FIG. 1 is a diagram for describing an intraoral image processing system according to an embodiment.

Referring to FIG. 1, the intraoral image processing system may include three-dimensional scanners 100 and 110 and a data processing device 120 connected to the three-dimensional scanners 100 and 110 through a communication network 130.

The three-dimensional scanners 100 and 110 may be medical devices for obtaining an image of an object.

The three-dimensional scanners 100 and 110 may obtain an image of at least one of an oral cavity, an artificial structure, or a plaster cast of an oral cavity or an artificial structure.

The three-dimensional scanners 100 and 110 may include at least one of an intraoral scanner 100 and a table scanner 110.

In an embodiment, the three-dimensional scanners 100 and 110 may include the intraoral scanner 100. The intraoral scanner 100 may be a handheld scanner for scanning an oral cavity while being held and moved by a user. The intraoral scanner 100, which is inserted into the oral cavity and scans teeth in a contactless manner, may obtain an image of an oral cavity including at least one tooth.

The intraoral scanner 100 may include a main body 101 and a tip 103. The main body 101 may include a light emitter (not shown) configured to project light, and a camera (not shown) configured to obtain an image by photographing an object.

The tip 103 is a part to be inserted into an oral cavity, and may be detachably mounted on the main body 101. The tip 103 may include an optical path changer to direct light emitted from the main body 101 toward an object, and direct light received from the object toward the main body 101.

The intraoral scanner 100 may obtain, as raw data, surface information about an object, in order to image the surface of at least one of a tooth, gingiva, and an artificial structure (e.g., an orthodontic device including a bracket and a wire, an implant, an artificial tooth, an orthodontic auxiliary tool inserted into the oral cavity, etc.).

In an embodiment, the three-dimensional scanners 100 and 110 may include the table scanner 110. The table scanner 110 may be configured to obtain surface information about an object 118 as raw data by scanning the object 118 while rotating a table 117. The table scanner 110 may scan the surface of the object 118, such as a plaster cast or impression of an oral cavity, an artificial structure that is insertable into an oral cavity, or a plaster cast or impression of an artificial structure.

The table scanner 110 may include an inner space recessed toward the inside of a housing 111. A moving portion 112 for holding and moving the object 118 may be formed on a side surface of the inner space. The moving portion 112 may vertically move in the z-axis direction. The moving portion 112 may include a fixed base 113 connected to a first rotating portion 114, the first rotating portion 114 that is rotatable in a first rotation direction M1 around a central axis on a point on the fixed base 113, for example, around the x-axis, and a beam portion 116 connected to the first rotating portion 114 and protruding from the first rotating portion 114. The beam portion 116 may be extended or shortened in the x-axis direction.

A cylindrical second rotating portion 115 that is rotatable in a second rotation direction M2 around the z-axis may be coupled to one end of the beam portion 116. The table 117 that rotates together with the second rotating portion 115 may be formed on one surface of the second rotating portion 115.

An optical portion 119 may be formed in the inner space. The optical portion 119 may include a light projection portion configured to project pattern light onto the object 118, and one or more cameras configured to receive the light reflected from the object 118 to obtain a plurality of two-dimensional frames. The optical portion 119 may further include a second rotating portion (not shown) that rotates around the center of the light projection portion as a rotation axis while being coupled to a side surface of the inner space. The second rotating portion may rotate the light projection portion and first and second cameras in a third rotation direction M3.

The three-dimensional scanners 100 and 110 may transmit the obtained raw data to the data processing device 120 through the communication network 130.

The data processing device 120 may be connected to the three-dimensional scanners 100 and 110 through the wired or wireless communication network 130. The data processing device 120 may be any electronic device capable of receiving raw data from the three-dimensional scanners 100 and 110 and generating, processing, displaying, and/or transmitting an intraoral image based on the received raw data. For example, the data processing device 120 may be a computing device such as a smart phone, a laptop computer, a desktop computer, a personal digital assistant (PDA), or a tablet personal computer (PC), but is not limited thereto. In addition, the data processing device 120 may be in the form of a server (or a server device) or the like for processing an intraoral image.

The data processing device 120 may generate a three-dimensional intraoral image or additional information by processing a two-dimensional image data based on two-dimensional image data received from the three-dimensional scanners 100 and 110. The data processing device 120 may display a three-dimensional intraoral image and/or additional information through a display 125, or output or transmit the three-dimensional intraoral image and/or the additional information to an external device.

As another example, the three-dimensional scanners 100 and 110 may obtain raw data through intraoral scanning, process the obtained raw data to generate three-dimensional data, and transmit the three-dimensional data to the data processing device 120.

In an embodiment, the three-dimensional scanners 100 and 110 may project pattern light onto an object, scan the object onto which the pattern light is projected, and obtain three-dimensional data representing the shape of the object by using the principle of triangulation based on distortion of a pattern.

In an embodiment, the three-dimensional scanners 100 and 110 may obtain three-dimensional data of the object by using a confocal method. The confocal method is a non-destructive optical imaging technique for three-dimensional surface measurement, and may obtain an optically sectioned image with a high spatial resolution by using a pinhole structure. The three-dimensional scanners 100 and 110 may obtain three-dimensional data by stacking two-dimensional images obtained in an axial direction.

However, this is an embodiment, and the three-dimensional scanners 100 and 110 may obtain three-dimensional data from raw data by using various methods other than the above method, and transmit the obtained three-dimensional data to the data processing device 120. The data processing device 120 may analyze, process, display, and/or transmit the received three-dimensional data.

In an embodiment, the data processing device 120 may obtain a plurality of three-dimensional intraoral images. As described above, a three-dimensional intraoral image may also be referred to as a scan model. The user may align a plurality of scan models by using the data processing device 120. To this end, the user may select scan models to be aligned from among the plurality of scan models by using the data processing device 120. When the scan models to be aligned are referred to as a first scan model and a second scan model, respectively, in an embodiment, the data processing device 120 may determine whether to initially align the first scan model and the second scan model.

In an embodiment, when it is determined not to initially align the first scan model and the second scan model, the data processing device 120 may omit initial alignment and precisely align the first scan model and the second scan model.

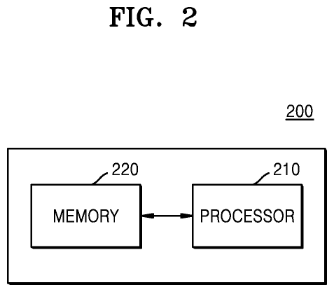

FIG. 2 is an internal block diagram of a data processing device according to an embodiment.

In an embodiment, a data processing device 200 may also be referred to as an intraoral image processing device.

The data processing device 200 of FIG. 2 may be an embodiment of the data processing device 120 of FIG. 1. Thus, the descriptions of the data processing device 120 of FIG. 1 provided above will be omitted.

The data processing device 300 may be an electronic device capable of generating, processing, processing, displaying, and/or transmitting an intraoral image by using raw data received from the three-dimensional scanners 100 and 110.

Referring to FIG. 2, the data processing device 200 may include a processor 210 and a memory 220.

In detail, the data processing device 200 may include the memory 220 storing one or more instructions, and the processor 210 configured to execute the one or more instructions stored in the memory 220. The processor 210 may execute the one or more instructions to obtain a first scan model and a second scan model, determine whether to initially align the first scan model and the second scan model, and in response to determining not to initially align the first scan model and the second scan model, precisely align the first scan model and the second scan model.

The data processing device 200 may generate a three-dimensional intraoral model, that is, a scan model, based on raw data received from the three-dimensional scanners 100 and 110. Alternatively, the data processing device 200 may receive a scan model from the three-dimensional scanners 100 and 110. Alternatively, the data processing device 200 may receive a scan model from an external server or an external device through a wired or wireless communication network.

In an embodiment, the memory 220 may store data received from the three-dimensional scanners 100 and 110, for example, raw data obtained by scanning an oral cavity or an oral cavity model. In addition, the memory 220 may store a scan model generated by the data processing device 200, received from the three-dimensional scanners 100 and 110, or received from an external server or an external device.

The memory 220 according to an embodiment may store at least one instruction. The memory 220 may store at least one instruction or program to be executed by the processor 210.

In an embodiment, the memory 220 may store a plurality of scan models.

In an embodiment, the memory 220 may store dedicated software for data alignment. The dedicated software for data alignment may be referred to as a dedicated program, a dedicated tool, or a dedicated application.

In an embodiment, the memory 220 may include one or more instructions for determining whether to initially align scan models to be aligned.

In an embodiment, the memory 220 may include one or more instructions for determining whether a relationship between scan models to be aligned satisfies a first alignment criterion.

In an embodiment, the memory 220 may include one or more instructions for initially aligning scan model to be aligned.

In an embodiment, the memory 220 may include one or more instructions for precisely aligning scan models to be aligned.

The processor 210 according to the embodiment may control the overall operation of the data processing device 200. The processor 210 may execute at least one instruction to control an intended operation to be performed. Here, the at least one instruction may be stored in the memory 220 included in the data processing device 200 separately from the processor 210 or in an internal memory (not shown) included in the processor 210.

In detail, the processor 210 may execute the at least one instruction to control at least one component included in the data processing device 200 such that an intended operation is performed. Therefore, although an example in which the processor 210 performs certain operations is described, it may mean that the processor 210 controls at least one component included in the data processing device 200 to perform the operations.

In an embodiment, the processor 210 may obtain three-dimensional intraoral images to be aligned. The processor 210 may obtain intraoral images to be aligned from among three-dimensional intraoral images generated based on raw data received from the three-dimensional scanners 100 and 110 or three-dimensional intraoral images obtained from the memory 220, the three-dimensional scanners 100 and 110, an external server or an external device, or the like.

For convenience of description, three-dimensional intraoral images to be aligned will be referred to as a first scan model and a second scan model, respectively.

In an embodiment, the processor 210 may determine whether to initially align the first scan model and the second scan model.

In an embodiment, the processor 210 may determine whether a relationship between the first scan model and the second scan model satisfies a first alignment criterion, and based on determining that the relationship between the first scan model and the second scan model satisfies the first alignment criterion, determine not to initially align the first scan model and the second scan model.

In an embodiment, the processor 210 may determine whether a distance between a point on the first scan model from which a normal vector is projected, and a point at which the normal vector intersects the second scan model, is less than or equal to a first threshold value. When the distance between the point on the first scan model from which the normal vector is projected, and the point at which the normal vector intersects the second scan model, is less than or equal to the first threshold value, the processor 210 may determine that the first alignment criterion is satisfied.

In an embodiment, the processor 210 may use various methods to determine whether the distance between the point on the first scan model from which the normal vector is projected, and the point at which the normal vector intersects the second scan model, is less than or equal to the first threshold value.

In an embodiment, the processor 210 may obtain distances between a plurality of points on the first scan model, and a plurality of points at which normal vectors projected from the plurality of points on the first scan model intersect the second scan model, respectively. The processor 210 may obtain a distance distribution from the distances between the pluralities of points, and obtain a statistical property value of the distance distribution. In response to the statistical property value of the distance distribution being less than or equal to the first threshold value, the processor 210 may determine that the relationship between the first scan model and the second scan model satisfies the first alignment criterion. The statistical property value may include at least one of a minimum, a maximum, a median, an average, an absolute average, a mode, a range, and a variance of the distance distribution.

In another embodiment, the processor 210 may obtain the proportion of distances that are less than or equal to the first threshold value, among the distances between the plurality of points on the first scan model, and the plurality of points at which the normal vectors projected from the plurality of points on the first scan model intersect the second scan model, respectively. The processor 210 may identify whether the proportion of the distances is greater than or equal to a reference value, and in response to the proportion of the distances being greater than or equal to the reference value, determine that the relationship between the first scan model and the second scan model satisfies the first alignment criterion.

However, this is an example, and the processor 210 may determine whether a distance between a point on the first scan model from which a normal vector is projected, and a point at which the normal vector intersects the second scan model, is less than or equal to the first threshold value by using various methods other than the method described above.

In an embodiment, when the distance between the point on the first scan model from which the normal vector is projected, and the point at which the normal vector intersects the second scan model, is less than or equal to the first threshold value, the processor 210 may determine that the first alignment criterion is satisfied.

In an embodiment, when the relationship between the first scan model and the second scan model satisfies the first alignment criterion, the processor 210 may determine not to initially align the first scan model and the second scan model. When the processor 210 determines not to initially align the first scan model and the second scan model, the processor 210 may directly perform precise alignment on the first scan model and the second scan model without performing initial alignment.

In an embodiment, the processor 210 may determine whether a relationship between the precisely aligned first scan model and second scan model satisfies the second alignment criterion.

In an embodiment, in order to determine whether the relationship between the precisely aligned first scan model and second scan model satisfies the second alignment criterion, the processor 210 may obtain a distance between a point on the precisely aligned first scan model from which a normal vector is projected, and a point at which the normal vector intersects the precisely aligned second scan model, and determine whether the obtained distance is less than or equal to a second threshold value. When the distance between the point on the precisely aligned first scan model from which the normal vector is projected, and the point at which the normal vector intersects the precisely aligned second scan model, is less than or equal to the second threshold value, the processor 210 may determine that the second alignment criterion is satisfied. In this case, the second threshold value used to determine whether the second alignment criterion is satisfied may be less than the first threshold value used to determine whether the first alignment criterion is satisfied.

In an embodiment, when it is determined that the relationship between the precisely aligned first scan model and second scan model does not satisfy the second alignment criterion, the processor 210 may initially align the precisely aligned first scan model and second scan model.

The reason why the relationship between the precisely aligned first scan model and second scan model does not satisfy the second alignment criterion may be because initial alignment has been performed on the first scan model and the second scan model with respect to an incorrect position. Thus, when the relationship between the precisely aligned first scan model and second scan model does not satisfy the second alignment criterion, the processor 210 may readjust the alignment position by first performing initial alignment.

In an embodiment, when it is determined that the relationship between the first scan model and the second scan model does not satisfy the first alignment criterion, the processor 210 may determine to initially align the first scan model and the second scan model. In this case, the processor 210 may initially align the first scan model and the second scan model, and precisely align the initially aligned first scan model and second scan model.

In an embodiment, the processor 210 may output a menu for selecting automatic alignment. When the menu for selecting automatic alignment is selected by the user, the processor 210 may determine whether to initially align the first scan model and the second scan model.

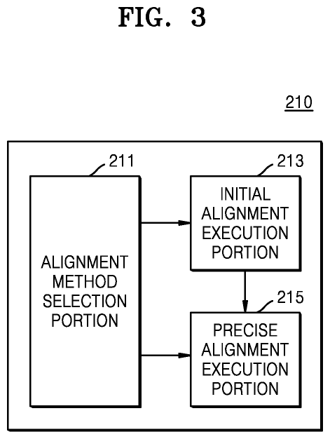

FIG. 3 is an internal block diagram of the processor of FIG. 2, according to an embodiment.

Referring to FIG. 3, the processor 210 may include an alignment method selection portion 211, an initial alignment execution portion 213, and a precise alignment execution portion 215.

In an embodiment, the alignment method selection portion 211 may determine whether to initially align scan models to be aligned. The alignment method selection portion 211 may obtain a relationship between a first scan model and a second scan model, which are to be aligned, and determine whether to perform initial alignment and whether to perform precise alignment, according to the relationship between the first scan model and the second scan model.

In order to determine whether to perform initial alignment, the alignment method selection portion 211 may determine whether the relationship between the first scan model and the second scan model satisfies a predefined criterion. Hereinafter, for convenience of description, the predefined criterion for the relationship between the first scan model and the second scan model used by the alignment method selection portion 211 to determine whether to perform initial alignment will be referred to as a first alignment criterion.

In an embodiment, the alignment method selection portion 211 may obtain a distance between the first scan model and the second scan model, and determine whether to perform initial alignment, based on whether the distance between the first scan model and the second scan model satisfies the first alignment criterion.

In an embodiment, the alignment method selection portion 211 may project a normal vector perpendicular to a tangent plane to a point on the first scan model onto the second scan model to obtain a point at which the normal vector intersects the second scan model. When the point on the first scan model is referred to as a first point, and the point at which the normal vector projected from the first point intersects the second scan model is referred to as a second point, the alignment method selection portion 211 may obtain a distance between the first point and the second point.

The alignment method selection portion 211 may project normal vectors from a plurality of points on the first scan model onto the second scan model to obtain distances between the plurality of points on the first scan model and a plurality of points on the second scan model, respectively.

In an embodiment, the alignment method selection portion 211 may obtain statistical properties of the distance distribution by using the distances between the pluralities of points. The statistical properties of the distance distribution may include at least one of a minimum, a maximum, a median, an average, an absolute average, a mode, a range, and a variance of the distances between the first scan model and the second scan model. The alignment method selection portion 211 may determine whether a statistical property value of the distance distribution is less than or equal to a first threshold value, and when the statistical property value of the distance distribution is less than or equal to the first threshold value, determine that the relationship between the first scan model and the second scan model satisfies the first alignment criterion.

For example, the alignment method selection portion 211 may obtain distances between a plurality of points on the first scan model and a plurality of points on the second scan model, and obtain an average of the distances between the pluralities of points, as a statistical property value of the distance distribution. When the average of the distances between the pluralities of points is less than or equal to the first threshold value, the alignment method selection portion 211 may determine that the relationship between the first scan model and the second scan model satisfies the first alignment criterion, and determine not to perform initial alignment.

In another embodiment, the alignment method selection portion 211 may obtain the proportion of distances that are less than or equal to the first threshold value, among the distances between the pluralities of points. When the proportion of distances that are less than or equal to the first threshold value is greater than or equal to a reference value, the alignment method selection portion 211 may determine that the relationship between the first scan model and the second scan model satisfies the first alignment criterion.

For example, the alignment method selection portion 211 may obtain distances between a plurality of points on the first scan model and a plurality of points on the second scan model, and obtain the percentage of points having distances less than or equal to the first threshold value among the distances between the pluralities of points. When the proportion of distances that are less than or equal to the first threshold value is greater than or equal to the reference value among the distances between the pluralities of points, for example, is 50% or less, the alignment method selection portion 211 may determine that the relationship between the first scan model and the second scan model satisfies the first alignment criterion, and determine not to perform initial alignment.

In an embodiment, precise alignment may refer to a three-dimensional transformation that maximizes overlapping portions between pieces of three-dimensional data through local search. On the contrary, initial alignment may refer to rough alignment of pieces of point cloud data through global search. Thus, even when the relationship between the first scan model and the second scan model satisfies the first alignment criterion, and the two scan models are initially aligned through global search, there is a possibility that the scan models are aligned to positions that is less relevant than before the initial alignment.

Therefore, in an embodiment, when the relationship between the first scan model and the second scan model satisfies the first alignment criterion, the alignment method selection portion 211 may determine not to perform initial alignment. In this case, the alignment method selection portion 211 may control the initial alignment execution portion 213 not to operate, and control the precise alignment execution portion 215 to precisely align the first scan model and the second scan model.

In an embodiment, the precise alignment execution portion 215 may precisely align the first scan model and the second scan model. In an embodiment, precise alignment may refer to a three-dimensional transformation that maximizes overlapping portions between pieces of three-dimensional data through local search. The precise alignment execution portion 215 may minimize a distance between overlapping portions in pieces of three-dimensional point cloud data such that a three-dimensional transformation is accurately performed.

In an embodiment, the precise alignment execution portion 215 may align two scan models to be aligned, by using an algorithm such as iterative closest point (ICP). ICP is an algorithm for minimizing a difference between two point clouds, and is used to reconstruct a two-dimensional or three-dimensional surface from different scan models. An ICP algorithm fixes a point cloud, which is referred to as a reference, and transforms a point cloud, which is referred to as a source, to best match the reference. The ICP algorithm may align a three-dimensional model by iteratively modifying transformation necessary to minimize an error metric representing the distance from the source to the reference, for example, a combination of translation and rotation. The precise alignment execution portion 215 may use various algorithms other than ICP, for example, the Kabsch algorithm, but is not limited thereto.

In an embodiment, when the relationship between the first scan model and the second scan model does not satisfy the first alignment criterion, and thus, it is determined to perform initial alignment, the alignment method selection portion 211 may control the initial alignment execution portion 213 to operate.

The initial alignment execution portion 213 may initially align the first scan model and the second scan model. In an embodiment, the initial alignment may be performed through global search, unlike the precise alignment.

In an embodiment, the initial alignment execution portion 213 may roughly align pieces of point cloud data through feature point extraction using three-dimensional geometric properties. Each of the first scan model and the second scan model may include a point cloud. The initial alignment execution portion 213 may obtain a first point cloud by downsampling the point cloud in the entire region of the first scan model, and obtain a first feature point from the first point cloud. In addition, the initial alignment execution portion 213 may obtain a second point cloud by downsampling the point cloud in the entire region of the second scan model, and obtain a second feature point from the second point cloud.

At least one of the first feature point and the second feature point may include a descriptor indicating a correlation between a normal vector for each point of at least one of the first point cloud and the second point cloud, and a neighboring point. The descriptor may be obtained based on at least one of a distance between the point and the neighboring point, and a difference in angle with the normal vector between the point and the neighboring point. The initial alignment execution portion 213 may initially align the first scan model and the second scan model by matching feature points having a difference between the first feature point and the second feature point less than or equal to a reference value.

The first scan model and the second scan model that are initially aligned by the initial alignment execution portion 213 may be transmitted to the precise alignment execution portion 215. The precise alignment execution portion 215 may precisely align the first scan model and the second scan model on which the initial alignment has been performed.

Thereafter, the processor 210 may determine whether a relationship between the precisely aligned first scan model and second scan model satisfies the second alignment criterion, and when the relationship between the precisely aligned first scan model and second scan model satisfies the second alignment criterion, terminate the alignment process.

The processor 210 may determine whether a distance between a point on the precisely aligned first scan model from which a normal vector is projected, and a point at which the normal vector intersects the precisely aligned second scan model, is less than or equal to a second threshold value, and when the distance is less than or equal to the second threshold value, determine that the second alignment criterion is satisfied. Here, the second threshold value used for the second alignment criterion may be less than the first threshold value used for the first alignment criterion.

When the relationship between the precisely aligned first scan model and second scan model does not satisfy the second alignment criterion, the processor 210 may control the initial alignment execution portion 213 to initially align the precisely aligned first scan model and second scan model again.

As described above, according to an embodiment, the alignment method selection portion 211 may determine whether to initially align two scan models to be aligned, and when a relationship between the two scan models satisfies the first alignment criterion, directly perform precision alignment without performing the initial alignment, thereby eliminating the possibility of alignment to irrelevant positions that may occur due to collectively performing the initial alignment again.

In addition, according to an embodiment, when the relationship between the two scan models to be aligned satisfies the first alignment criterion, the alignment method selection portion 211 may omit the initial alignment and directly perform the precise alignment, thereby reducing the amount of unnecessary computation and time required to initially align the scan models.

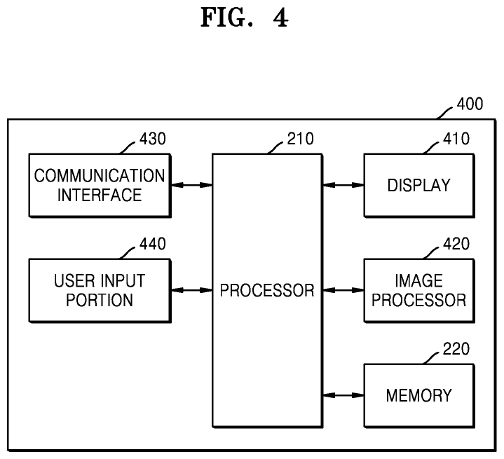

FIG. 4 is a diagram illustrating an example of the data processing device of FIG. 2.

Referring to FIG. 4, a data processing device 400 may further include a display 410, an image processor 420, a communication interface 430, and a user input portion 440, in addition to the processor 210 and the memory 220.

The processor 210 and the memory 220 included in the data processing device 400 of FIG. 4 performs the same functions as those of the processor 210 and the memory 220 included in the data processing device 200 of FIG. 2, and thus are illustrated with the same reference numerals. Hereinafter, the descriptions of the data processing device 200 of FIG. 2 provided above will be omitted.

The display 410 according to an embodiment may output a scan model. The display 410 may output a first scan model and a second scan model, which are selected by a user through the user input portion 440 from among a plurality of scan models, on separate screens or together on one screen.

In an embodiment, the display 410 may output an automatic alignment selection menu for receiving, from the user, a selection for scan model alignment. In response to the automatic alignment selection menu output by the display 410, the user may select a menu for scan model selection through the user input portion 440.

In an embodiment, the display 410 may output a result in which the first scan model and the second scan model are aligned with each other. For example, the display 410 may output a state in which the smaller scan model is aligned to the larger scan model among the two scan models.

The image processor 420 according to an embodiment may perform operations for generating and/or processing an image. The image processor 420 may generate a scan model based on raw data received from the three-dimensional scanners 100 and 110.

In an embodiment, the image processor 420 may align the first scan model and the second scan model under control of the processor 210.

The image processor 420 may align the first scan model and the second scan model such that overlapping portions between the first scan model and the second scan model are maximized and a distance between the overlapping portions is minimized.

The communication interface 430 according to an embodiment may communicate with at least one external electronic device through a wired or wireless communication network.

For example, the communication interface 430 may communicate with the three-dimensional scanners 100 and 110 under control of the processor 210. In an embodiment, the communication interface 430 may receive raw data from the three-dimensional scanners 100 and 110 or obtain a scan model. In an embodiment, the communication interface 430 may obtain a scan model by performing communication with an external electronic device, an external server, or the like other than the three-dimensional scanners 100 and 110.

The communication interface 430 may include at least one short-range communication module configured to communicate according to a communication standard such as Bluetooth, Wi-Fi, Bluetooth Low Energy (BLE), near-field communication (NFC)/radio-frequency identification (RFID), Wi-Fi Direct, ultra-wideband (UWB), or Zigbee.

In addition, the communication interface 430 may further include a long-range communication module configured to communicate with a server for supporting long-range communication according to a long-range communication standard. In detail, the communication interface 430 may include a long-range communication module configured to communicate through a network for Internet communication. For example, the communication interface 430 may include a communication module configured to communicate through a communication network conforming to a mobile communication standard, such as 3^{rd} Generation (3G), 4^{th} Generation (4G), and/or 5^{th} Generation (5G).

In addition, the communication interface 430 may communicate with the three-dimensional scanners 100 and 110, an external server, an external electronic device, or the like in a wired manner. To this end, the communication interface 430 may include at least one port to be connected to the three-dimensional scanners 100 and 110 or an external electronic device through a cable. The communication interface 430 may communicate with the three-dimensional scanners 100 and 110 or an external electronic device connected thereto through the at least one port.

In an embodiment, the communication interface 430 may transmit, to an external electronic device or an external server, the result in which the first scan model and the second scan model are aligned with each other. For example, the communication interface 430 may transmit, to an external electronic device or an external server, a result in which the smaller scan model is aligned to the larger scan model among the two scan models.

The user input portion 440 according to an embodiment may receive a user input for controlling the data processing device 400. The user input portion 440 may include, but is not limited to, a touch panel for detecting a touch of the user, a button for receiving a push manipulation by the user, and a user input device including a mouse or a keyboard for designating or selecting a point on a user interface screen. In addition, the user input portion 440 may include a speech recognition device for speech recognition. For example, the speech recognition device may be a microphone, and may receive a voice command or a voice request of the user. Accordingly, the processor 210 may control an operation corresponding to the voice command or voice request to be performed.

In an embodiment, the user input portion 440 may receive a selection of a first scan model and a second scan model, from the user such as a dentist.

In an embodiment, the user input portion 440 may receive, from the user, a selection to automatically align the first scan model and the second scan model.

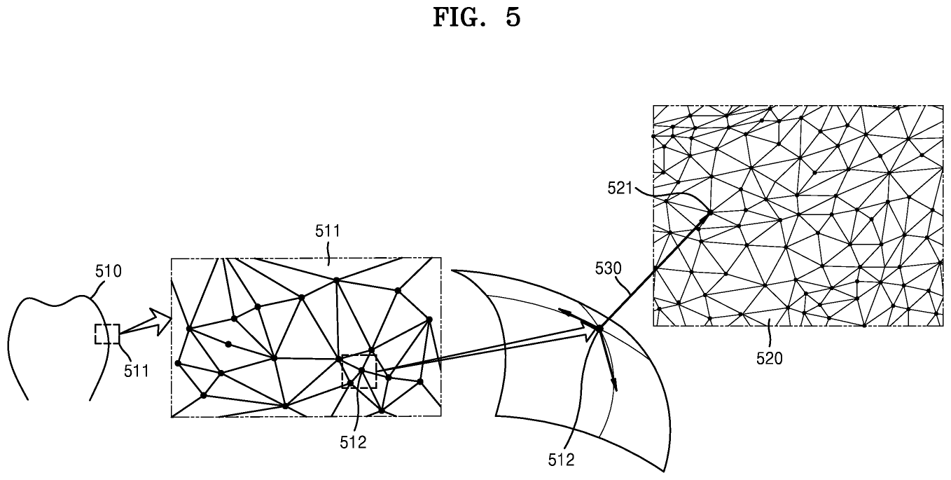

FIG. 5 is a diagram for describing a method, performed by a data processing device, of determining whether to perform initial alignment, according to an embodiment.

In an embodiment, the data processing device may use a normal vector to determine whether initial alignment is necessary for aligning a first scan model and a second scan model. The normal vector may refer to a vector having a direction perpendicular to a tangent plane including tangents to a point on a two-dimensional curved surface in a three-dimensional space.

The data processing device may project a normal vector perpendicular to a tangent plane to a point on a first scan model 510 onto a second scan model 520, to identify a point at which the normal vector intersects a point on the second scan model 520.

FIG. 5 illustrates that a normal vector is projected from a first point 512 included in a first region 511 of the first scan model 510 to a second point 521 of the second scan model 520. As illustrated in FIG. 5, the data processing device may identify the second point 521 at which the normal vector projected from the first point 512 on the first scan model 510 intersects the second scan model 520, and obtain a distance 530 of the normal vector between the first point 512 and the second point 521.

In an embodiment, the data processing device may project normal vectors from a plurality of points on the first scan model 510 to obtain distances between the plurality of points on the first scan model 510 and a plurality of points at which the respective normal vectors intersect the second scan model 520, and determine whether a relationship between the first scan model 510 and the second scan model 520 satisfies a first alignment criterion, by using the distances between the pluralities of points.

For example, the data processing device may obtain a statistical property value of the distribution of the distances between the plurality of points on the first scan model 510 and the plurality of points on the second scan model 520, and when the statistical property value is less than or equal to a first threshold value, determine that the relationship between the first scan model 510 and the second scan model 520 satisfies the first alignment criterion.

Alternatively, the data processing device may obtain the proportion of distances that are less than or equal to the first threshold value among the distances between the plurality of points on the first scan model 510 and the plurality of points on the second scan model 520, and when the proportion of the distances is greater than or equal to a reference value, determine that the relationship between the first scan model and the second scan model satisfies the first alignment criterion.

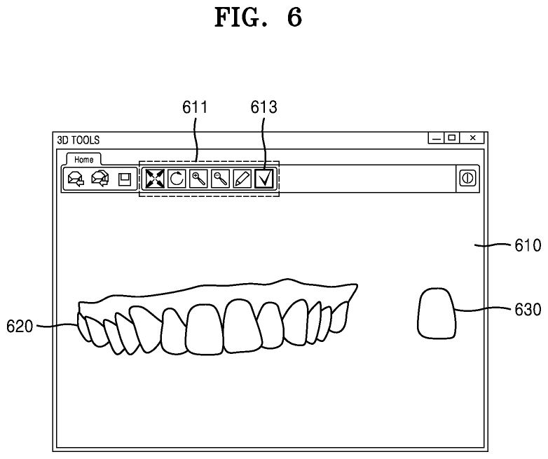

FIG. 6 is a diagram for describing a method, performed by a data processing device, of performing automatic alignment, according to an embodiment.

The data processing device may obtain a three-dimensional intraoral image obtained by scanning a patient's oral cavity.

In an embodiment, the data processing device may receive, from a user, a selection of alignment targets from among a plurality of three-dimensional intraoral images.

In an embodiment, the data processing device may output, through a display 610, a first scan model 620 and a second scan model 630, which are selected by the user as alignment targets.

The data processing device may output, through the display 610, a menu bar 611 including at least one menu for editing or changing a three-dimensional intraoral image. For example, the menu bar 611 may include menus for selecting, enlarging, reducing, and viewing the three-dimensional intraoral image in a full screen, viewing a previous image, changing an angle or position, rotating, and the like.

In an embodiment, the menu bar 611 may include an automatic alignment menu 613. Alternatively, in another embodiment, the automatic alignment menu 613 may not be included in the menu bar 611 and may be output in a position separate from the menu bar 611. For example, the automatic alignment menu 613 may be output on the left or right side of the display 610 or between the first scan model 620 and the second scan model 630.

In an embodiment, when the automatic alignment menu 613 is selected by the user, the data processing device may align the first scan model 620 and the second scan model 630.

In an embodiment, when the automatic alignment menu 613 is selected by the user, the data processing device may determine whether to initially align the first scan model 620 and the second scan model 630. The data processing device may obtain a relationship between the first scan model 620 and the second scan model 630, determine whether the relationship between the first scan model 620 and the second scan model 630 satisfies the first alignment criterion, and determine whether to initially align the first scan model 620 and the second scan model 630.

In an embodiment, the data processing device may determine whether a distance between a point on one of the two scan models, for example, the smaller second scan model 630, from which a normal vector is projected, and a point at which the normal vector intersects the first scan model 620 is less than or equal to a first threshold value, so as to determine whether the relationship between the first scan model 620 and the second scan model 630 satisfies the first alignment criterion.

In another embodiment, when the user designates one of the two scan models as reference data and the other as target data, the data processing device may project a normal vector from the model designated as the target data to the model designated as the reference data to determine whether to perform initial alignment, according to a relationship between the reference data and the target data.

Here, the reference data is data to be referred, and may refer to basic standard data. The reference data may refer to data that may be used as a comparison standard with the target data.

The target data is data to be a target, and may refer to data that is a target to be compared. That is, the target data may refer to a target for which a degree of deviation from the reference data is to be identified.

For example, when the user designates the first scan model 620 as the reference data and the second scan model 630 as the target data, the data processing device may project a normal vector from the second scan model 630 designated as the target data to the first scan model 620 designated as the reference data. The data processing device may determine whether to initially align the first scan model 620 and the second scan model 630 according to whether a distance between the point from which the normal vector is projected, and the point at which the normal vector intersects the first scan model 620 is less than or equal to the first threshold value.

As illustrated in FIG. 6, when the first scan model 620 and the second scan model 630 are far from each other on the display 610, the distance between the first scan model 620 and the second scan model 630 is greater than the first threshold value, and thus, the relationship between the first scan model 620 and the second scan model 630 does not satisfy the first alignment criterion. In this case, the data processing device may determine to initially align the first scan model 620 and the second scan model 630, and then initially align the two scan models. Thereafter, the data processing device may precisely align the initially aligned scan models.

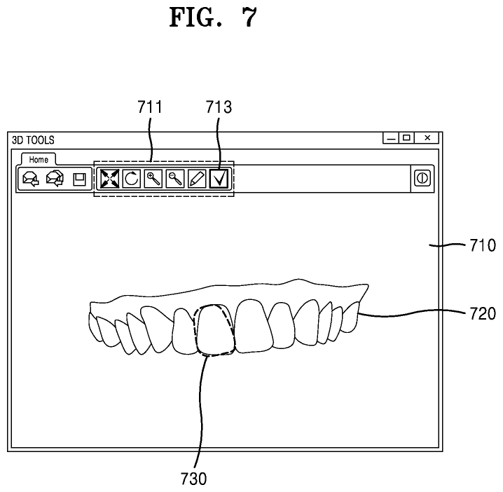

FIG. 7 is a diagram for describing a method, performed by a data processing device, of performing automatic alignment, according to another embodiment.

FIG. 7 is a diagram illustrating a result of, by the data processing device, initially aligning the first scan model 620 and the second scan model 630, and then precisely aligning the first scan model 620 and the second scan model 630, according to the method described above with reference to FIG. 6.

Referring to FIG. 7, the data processing device may output, through a display 710, a first scan model 720 and a second scan model 730, which are automatically aligned.

In an embodiment, the data processing device may output a menu bar 711 through the display 710. In an embodiment, an automatic alignment menu 713 may be included in the menu bar 711. Alternatively, in an embodiment, the automatic alignment menu 713 may be output on the display 710 separately from the menu bar 711.

In some cases, the user may think that the result output through the display 710 is not satisfactory. For example, the user may think that the result of the automatic alignment is not accurate. In this case, the user may select the automatic alignment menu 713 output through the display 710 of the data processing device again.

In an embodiment, in response to the user selecting the automatic alignment menu 713, the data processing device may perform automatic alignment.

In an embodiment, the data processing device may determine whether to initially align the automatically aligned first scan model 720 and second scan model 730. The data processing device may determine whether a relationship between the automatically aligned first scan model 720 and second scan model 730 satisfies the first alignment criterion, and based on a result of the determining, determine whether to initially align the automatically aligned first scan model 720 and second scan model 730.

In an embodiment, the data processing device may project a normal vector from one of the two scan models, for example, from the automatically aligned second scan model 730, to the automatically aligned first scan model 720, and determine whether a distance between a point from which the normal vector is projected, and a point at which the normal vector intersects the automatically aligned first scan model 720 is less than or equal to a first threshold value, so as to determine whether the relationship between the automatically aligned first scan model 720 and second scan model 730 satisfies the first alignment criterion.

As illustrated in FIG. 7, the automatically aligned first scan model 720 and second scan model 730 are already close to each other, and thus, the distance between the automatically aligned first scan model 720 and second scan model 730 is less than the first threshold value for determining whether to perform initial alignment.

In an embodiment, because the distance between the automatically aligned first scan model 720 and second scan model 730 is less than the first threshold value, the data processing device may determine that the relationship between the automatically aligned first scan model 720 and second scan model 730 satisfies the first alignment criterion, and thus determine not to initially align the automatically aligned first scan model 720 and second scan model 730.

In an embodiment, the data processing device may omit initial alignment of the automatically aligned first scan model 720 and second scan model 730, and perform only precise alignment. The data processing device may perform precise alignment through local search. Thus, the automatically aligned first scan model 720 and second scan model 730 may be aligned such that overlapping portions therebetween are maximized within a range that does not deviate from the current alignment position by a preset range or greater.

As such, according to an embodiment, the data processing device may perform only precise alignment on scan models on which alignment has already been performed to some extent, such as the automatically aligned first scan model 720 and second scan model 730, thereby preventing initial alignment from being performed again with respect to a position deviating from the current alignment position by a preset range or greater through global search.

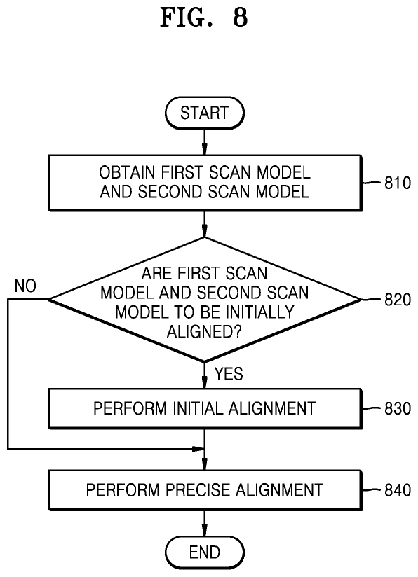

FIG. 8 is a flowchart illustrating a process of automatically aligning scan models, according to an embodiment.

Referring to FIG. 8, the data processing device may obtain alignment targets. For example, the data processing device may obtain a first scan model and a second scan model as alignment targets (operation 810).

The data processing device may determine whether to initially align the first scan model and the second scan model (operation 820).

The data processing device may determine whether to initially align the first scan model and the second scan model according to whether a relationship between the first scan model and the second scan model satisfies a first alignment criterion.

When it is determined to initially align the first scan model and the second scan model, the data processing device may initially align the first scan model and the second scan model (operation 830).

The data processing device may obtain a first point cloud and a second point cloud by downsampling the point clouds in the entire regions of the first scan model and the second scan model, respectively, and obtain a first feature point from the first point cloud, and a second feature point from the second point cloud.

The data processing device may obtain a descriptor indicating a correlation between at least one normal vector for each point in each of the first point cloud and the second point cloud, and a neighboring point. The data processing device may obtain the descriptor based on at least one of a distance between the point and the neighboring point, and a difference in angle with the normal vector between the point and the neighboring point.

The data processing device may initially align the first scan model and the second scan model by matching feature points having a relationship between the descriptors less than or equal to a reference value.

When it is determined not to initially align the first scan model and the second scan model, the data processing device may precisely align the first scan model and the second scan model without performing initial alignment (operation 840).

The data processing device may perform a three-dimensional transformation to maximize overlapping portions between the first scan model and the second scan model through local search. The data processing device may accurately perform the three-dimensional transformation by minimizing a distance between overlapping portions in pieces of point cloud data included in the first scan model and the second scan model.

The data processing device may precisely align the two scan models that are alignment targets, by using an algorithm such as ICP.

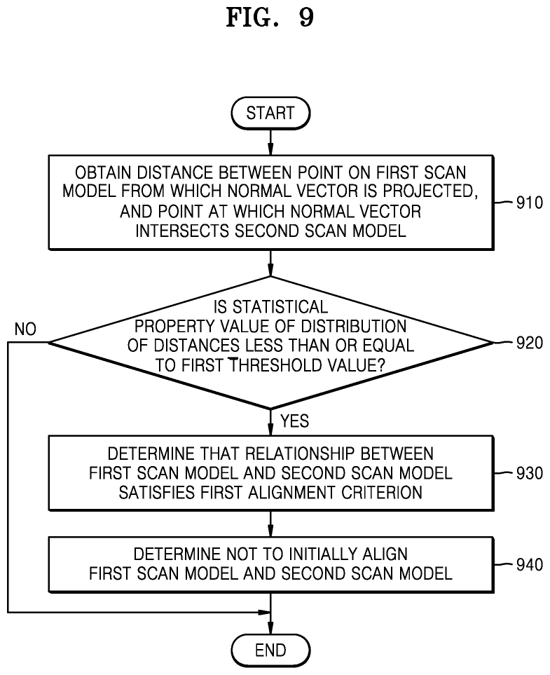

FIG. 9 is a flowchart illustrating a method of determining to omit initial alignment of scan models, according to an embodiment.

Referring to FIG. 9, the data processing device may determine whether to omit initial alignment according to a relationship between a first scan model and a second scan model.

To this end, the data processing device may obtain a distance between a point on the first scan model from which a normal vector is projected, and a point at which the normal vector intersects the second scan model (operation 910).

The data processing device may obtain distances between a plurality of points on the first scan model, and a plurality of points at which normal vectors projected from the plurality of points on the first scan model intersect the second scan model, respectively.

The data processing device may obtain a distribution of distances from the distances between the pluralities of points, and identify a statistical property value of the distribution of the distances. In an embodiment, the statistical property value may include at least one of a minimum, a maximum, a median, an average, an absolute average, a mode, a range, and a variance of the distribution of the distances.

The data processing device may determine whether the statistical property value of the distribution of the distances is less than or equal to a first threshold value (operation 920).

When the statistical property value of the distribution of the distances is greater than the first threshold value, the data processing device may determine that a relationship between the first scan model and the second scan model does not satisfy a first alignment criterion, and determine to omit initial alignment.

In response to the statistical property value being less than or equal to the first threshold value, the data processing device may determine that the relationship between the first scan model and the second scan model satisfies the first alignment criterion (operation 930).

When it is determined that the relationship between the first scan model and the second scan model satisfies the first alignment criterion, the data processing device may determine not to initially align the first scan model and the second scan model (operation 940). In this case, the data processing device may precisely align the first scan model and the second scan model.

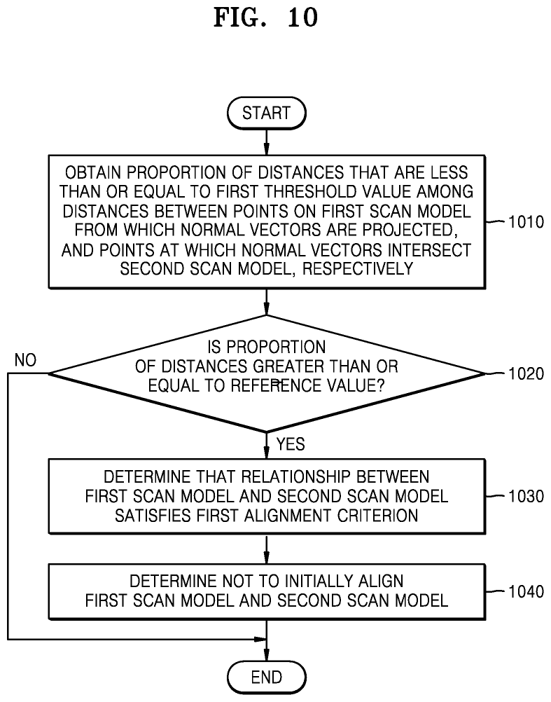

FIG. 10 is a flowchart illustrating a method of determining to omit initial alignment of scan models, according to another embodiment.

Referring to FIG. 10, the data processing device may obtain the proportion of distances that are less than or equal to a first threshold value among distances between points on a first scan model from which normal vectors are projected, and points at which the normal vectors intersect a second scan model, respectively (operation 1010).

The data processing device may determine whether the proportion of distances that are less than or equal to the first threshold value, among the distances between the plurality of points on the first scan model, and the plurality of points at which the normal vectors projected from the plurality of points on the first scan model intersect the second scan model, respectively, is greater than or equal to a reference value (operation 1020).

When the proportion of distances that are less than or equal to the first threshold value is less than the reference value, the data processing device may determine that a relationship between the first scan model and the second scan model does not satisfy a first alignment criterion, and determine to omit initial alignment.

When the proportion of distances that are less than or equal to the first threshold value is greater than or equal to the reference value, the data processing device may determine that the relationship between the first scan model and the second scan model satisfies the first alignment criterion (operation 1030).

When it is determined that the relationship between the first scan model and the second scan model satisfies the first alignment criterion, the data processing device may determine not to initially align the first scan model and the second scan model (operation 1040). The data processing device may precisely align the first scan model and the second scan model.

A data processing method according to an embodiment of the present disclosure may be embodied as program instructions executable by various computer devices, and then recorded on a computer-readable medium. In addition, an embodiment of the present disclosure may be implemented in a computer-readable recording medium having recorded thereon one or more programs including instructions for executing the data processing method.

In addition, a data processing method according to an embodiment of the present disclosure may include obtaining a first scan model and a second scan model, determining whether to initially align the first scan model and the second scan model, and in response to determining not to initially align the first scan model and the second scan model, precisely aligning the first scan model and the second scan model, and the data processing method may be implemented as a computer program product including a computer-readable recording medium having recorded thereon a program for causing a data processing device to perform the data processing method.

The computer-readable recording medium may include program instructions, data files, data structures, or the like separately or in combinations. Examples of the computer-readable recording medium may include magnetic media such as hard disks, floppy disks, or magnetic tapes, optical media such as a compact disc read-only memory (ROM) (CD-ROM) or a digital video discs (DVD), magneto-optical media such as floptical disks, and hardware devices such as ROM, random-access memory (RAM), and flash memory, which are configured to store and execute program instructions.

The machine-readable storage medium may be provided in the form of a non-transitory storage medium. The ‘non-transitory storage medium’ may mean that the storage medium is a tangible device. In addition, the ‘non-transitory storage medium’ may include a buffer in which data is temporarily stored.

According to an embodiment, the data processing method according to various embodiments disclosed herein may be provided in a computer program product. The computer program product may be distributed in the form of a machine-readable storage medium (e.g., a CD-ROM). Alternatively, the computer program product may be distributed (e.g., downloaded or uploaded) online through an application store (e.g., PlayStore™, etc.) or directly between two user devices (e.g., smart phones). In detail, the computer program product according to an embodiment of the present disclosure may include a storage medium having recorded thereon a program including at least one instruction for performing the data processing method according to an embodiment of the present disclosure.

Although embodiments have been described above in detail, the scope of the present disclosure is not limited thereto, and various modifications and alterations by those skill in the art using the basic concept of the present disclosure defined in the following claims also fall within the scope of the present disclosure.

1. A data processing method performed by a data processing device, the data processing method comprising:
obtaining a first scan model and a second scan model;
determining whether to initially align the first scan model and the second scan model; and
in response to determining not to initially align the first scan model and the second scan model, precisely aligning the first scan model and the second scan model.

2. The data processing method of claim 1, wherein the determining of whether to initially align the first scan model and the second scan model comprises:
determining whether a relationship between the first scan model and the second scan model satisfies a first alignment criterion; and
in response to determining that the relationship between the first scan model and the second scan model satisfies the first alignment criterion, determining not to initially align the first scan model and the second scan model.

3. The data processing method of claim 2, wherein the determining of whether the relationship between the first scan model and the second scan model satisfies the first alignment criterion comprises:
determining whether a distance between a point on the first scan model from which a normal vector is projected, and a point at which the normal vector intersects the second scan model, is less than or equal to a first threshold value; and
in response to the distance being less than or equal to the first threshold value, determining that the first alignment criterion is satisfied.

4. The data processing method of claim 3, wherein the determining of whether the distance between the point on the first scan model from which the normal vector is projected, and the point at which the normal vector intersects the second scan model, is less than or equal to the first threshold value comprises:
obtaining distances between a plurality of points on the first scan model, and a plurality of points at which the normal vectors intersect the second scan model, respectively; and
in response to a statistical property value of a distribution of the distances being less than or equal to the first threshold value, determining that the relationship between the first scan model and the second scan model satisfies the first alignment criterion, and
the statistical property value comprises at least one of a minimum, a maximum, a median, an average, an absolute average, a mode, a range, and a variance of the distribution of the distances.

5. The data processing method of claim 3, wherein the determining of whether the distance between the point on the first scan model from which the normal vector is projected, and the point at which the normal vector intersects the second scan model, is less than or equal to the first threshold value comprises:
obtaining a proportion of distances that are less than or equal to the first threshold value, among distances between a plurality of points on the first scan model, and a plurality of points at which the normal vectors intersect the second scan model, respectively; and
in response to the proportion of the distances being greater than or equal to a reference value, determining that the relationship between the first scan model and the second scan model satisfies the first alignment criterion.

6. The data processing method of claim 3, further comprising:
determining whether a relationship between the precisely aligned first scan model and second scan model satisfies a second alignment criterion; and
in response to determining that the relationship between the precisely aligned first scan model and second scan model does not satisfy the second alignment criterion, initially aligning the precisely aligned first scan model and second scan model,
wherein the determining of whether the relationship between the precisely aligned first scan model and second scan model satisfies the second alignment criterion comprises:
determining whether a distance between a point on the precisely aligned first scan model from which a normal vector is projected, and a point at which the normal vector intersects the precisely aligned second scan model, is less than or equal to a second threshold value; and
in response to the distance between the point on the precisely aligned first scan model from which the normal vector is projected, and the point at which the normal vector intersects the precisely aligned second scan model, being less than or equal to the second threshold value, determining that the second alignment criterion is satisfied, and
the second threshold value is less than the first threshold value.

7. The data processing method of claim 1, further comprising:
in response to determining to initially align the first scan model and the second scan model, initially aligning the first scan model and the second scan model; and
precisely aligning the initially aligned first scan model and second scan model.

8. The data processing method of claim 1, further comprising outputting a user interface screen for selecting automatic alignment,
wherein the determining of whether to initially align the first scan model and the second scan model is performed in response to the automatic alignment being selected on the user interface screen.

9. A data processing device comprising a processor configured to execute one or more instructions to obtain a first scan model and a second scan model, determine whether to initially align the first scan model and the second scan model, and in response to determining not to initially align the first scan model and the second scan model, precisely align the first scan model and the second scan model.

10. A computer-readable recording medium having recorded thereon a program for executing a data processing method, the data processing method comprising:
obtaining a first scan model and a second scan model;
determining whether to initially align the first scan model and the second scan model; and
in response to determining not to initially align the first scan model and the second scan model, precisely aligning the first scan model and the second scan model.
